(19) United States
(12) Patent Application Publication
(10) Pub. No.: US 2008/0179883 A1
(43) Pub. Date: Jul. 31, 2008

(54) RAPIDLY ENGAGING FEMALE THREADED COUPLER

(75) Inventor: Robert L. Fullerton, Reno, NV (US)

Correspondence Address: RAUSCHENBACH PATENT LAW GROUP, LLC, P.O. BOX 387, BEDFORD, MA, 01730, US

(73) Assignee: FULLERTON FASTENING SYSTEMS LLC, East Granby, CT (US)

(21) Appl. No.: 12/021,367

(22) Filed: Jan. 29, 2008

Related U.S. Application Data
(60) Provisional application No. 60/887,195, filed on Jan. 30, 2007.

(51) Int. Cl. F16L 25/04

(52) U.S. Cl. 285/330

(57) ABSTRACT

A threaded coupler includes a plurality of circumferentially distributed internally threaded segments arranged to create a bore for inserting an externally threaded member. A casing surrounds the threaded segments. The casing includes a first inclined surface of revolution extending at an acute angle to an axis of the coupler. A spring resiliently urges the segments radially inward to the axis of the coupler. Each of the plurality of segments includes an inclined surface which defines a second inclined surface of revolution co-acting with the first inclined surface of revolution of the casing.

### RELATED APPLICATION SECTION

This application claims priority to U.S. Provisional Patent Application Ser. No. 60/887,195, filed Jan. 30, 2007, entitled “Rapidly Engaging Female Threaded Coupler Nut”, the entire application of which is incorporated herein by reference.

The section headings used herein are for organizational purposes only and should not to be construed as limiting the subject matter described in the present application.

### BACKGROUND

This invention relates generally to female threaded coupling devices (nuts) or adaptors, and in the one embodiment, to a hose coupler, which can be rapidly engaged upon a threaded nozzle.

One embodiment of the present invention relates to a hose coupler, which can rapidly engage upon threaded spigot nozzles, such as common garden hose spigot nozzles. However, the invention could be applied to numerous applications, such as threaded fire hydrant nozzles. The ability of this invention to rapidly engage upon threaded spigot nozzles shortens the otherwise tedious task of turning a threaded hose coupler multiple revolutions to tighten a hose upon a spigot nozzle. This task can be especially tedious and painful for arthritic individuals who have a limited range of motion in their hands. Furthermore, situations such as fire emergencies require fast action to save lives and structures. Time wasted in threading common fire hose adaptors to a hydrant can mean the difference between life and death.

Efforts have been made to design threaded coupling devices, which may be assembled by rapid axial movement upon an externally threaded member such as a bolt. Examples of such devices are present in U.S. Pat. Nos. 4,378,187; 5,580,200 and 6,361,260. These devices depend upon a plurality of threaded segments located inside an external casing. The interior diameter of the threaded segments defines a threaded bore for inserting an externally threaded member. Each threaded segment has two axially spaced upper and lower frustoconical surfaces which co-act with two axially spaced annular upper and lower frustoconical surfaces cut into the inside diameter of the casing. Generally, a garter spring expandably encircling the segments or a wave spring for forcing the segments downward, provides the necessary force for urging the segments together and allowing the expansion and contraction of the segments as they move along the frustoconical surfaces of the casing. The threaded segments are held within the casing by various arrangements of segment pins which typically are positioned near the top of the casing, far from the end in which the externally threaded member is inserted.

A problem with the known designs is that if the segments are designed with loose tolerances between the adjoining surfaces, especially along their upper inclined edges, the threaded segments can roll into and out of the casing, even after assembly. Furthermore, the existence of a second, top, inclined surface protruding into the casing and/or the top positioning of segment pins in the casing can obstruct the path of the threaded segments during assembly, and thereby makes only hand assembly of the prior art devices possible, leading to increased labor costs. Also, with the prior art dual inclined surface assembles, the axial distance tolerances between the inclined surfaces on the casing versus the segments have to match extremely close. Otherwise the load of a large pulling force on a threaded member is distributed almost entirely upon the lower inclined surfaces of the casing and segments, causing the assembly to fail, and the threaded member to pull out.

Furthermore, the prior art devices fail to solve the problem of “thread segment identity” which is where a thread segment must be identified and properly placed in the fastener assembly so that mismatches between the threads of adjacent thread segments are avoided. As a result, if threads segments are not identified properly, this can lead to the wrong segments being placed side-by-side during assembly. This can result in mismatch between adjacent threads of the thread segments, thereby making it impossible to properly engage the fastener upon an externally threaded member, such as a bolt.

### BRIEF DESCRIPTION OF THE DRAWINGS

The aspects of this invention may be better understood by referring to the following description in conjunction with the accompanied drawings, in which like numerals indicate like structural elements and features in various figures. The drawings are not necessarily to scale. A skilled artisan will understand that the drawings, described below, are for illustration purposes only. The drawings are not intended to limit the scope of the present teachings in any way.

FIG. 1A is a perspective view of the hose coupler.

FIG. 1B is an exploded view of the hose coupler of FIG. 1A.

FIG. 2 is a cross-sectional view of the hose-coupler of FIG. 1A taken through line 2-2 of FIG. 1A.

FIG. 3 is a cross-sectional view showing the hose coupler of FIG. 1A, mounted on a garden hose spigot nozzle, with a garden hose attached.

FIG. 4 is a perspective view of a casing in accordance with the invention of FIG. 1A.

FIG. 5 is a top plan view of the casing of FIG. 4.

FIG. 6 is a cross-sectional view of the casing of FIG. 4 taken along line 6-6 of FIG. 5.

FIG. 7 is a perspective view of three-segments arranged, as they would be in the coupler of FIG. 1A.

FIG. 8 is a cross-sectional view of a segment co-acting with a partial cross sectional side of a casing in accordance with the invention.

FIG. 9 is a cross-sectional view of a prior art fastener segment co-acting with a partial cross sectional side of a prior art casing.

FIG. 10 is a close-up side view of the top cover in accordance with the invention.

FIG. 11A is a front elevational view of a segment having a grooved right side in accordance with the invention.

FIG. 11B is a front elevational view of a segment having a grooved left side in accordance with the invention.

FIG. 11C is a front elevational view of a segment having no grooves in accordance with the invention.

FIG. 12 is an insertion end view of four segments assembled into the coupler.

### DETAILED DISCLOSURE OF THE INVENTION

Reference in the specification to the word “embodiment” means that a particular feature, structure, or characteristic described in connection with the embodiment is included in at least one embodiment of the invention. The appearances of the word “embodiment” in various places in the specification are not necessarily all referring to the same embodiment.

It should be understood that the individual steps of the methods of the present invention may be performed in any order and/or simultaneously as long as the invention remains operable. Furthermore, it should be understood that the apparatus and methods of the present invention can include any number or all of the described embodiments as long as the invention remains operable.

The present invention will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

The present invention relates to a quickly engageable hose-coupling device. The hose-coupling device includes a casing, a plurality of individually identifiable threaded segments having a single inclined surface design, the single inclined surface co-acting with a single inclined surface on the casing. A single segment pin holds the threaded segments within the casing. A spring, such as a wave spring, is included to bias the segments toward the insert opening of the device.

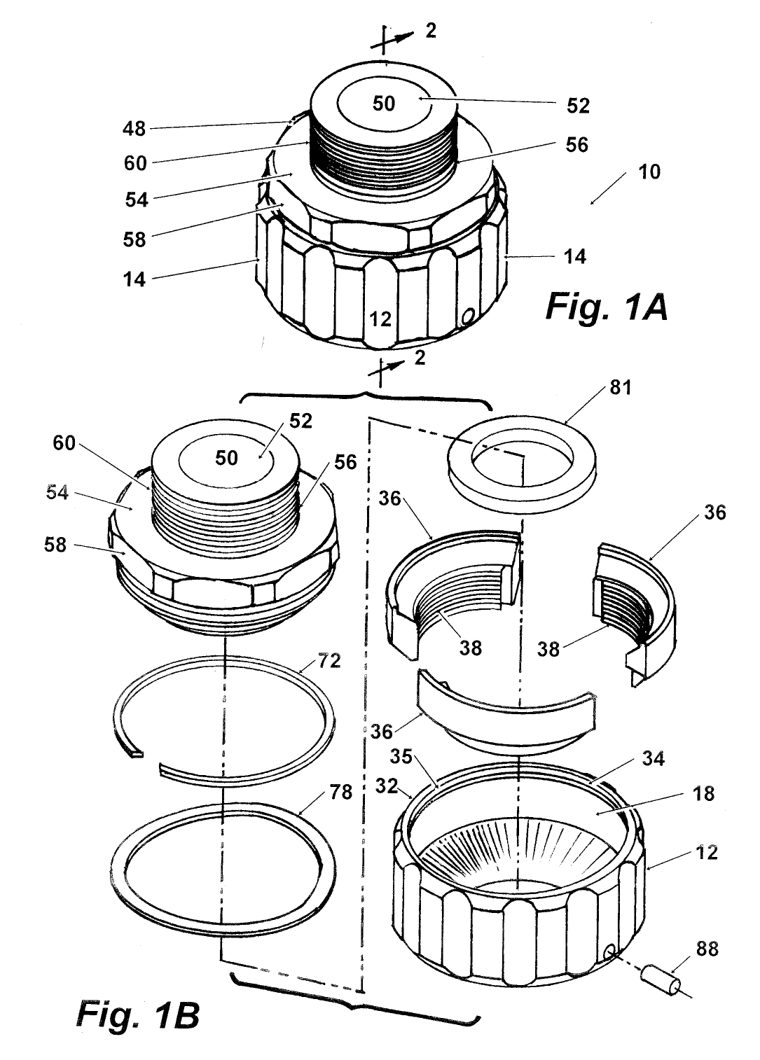

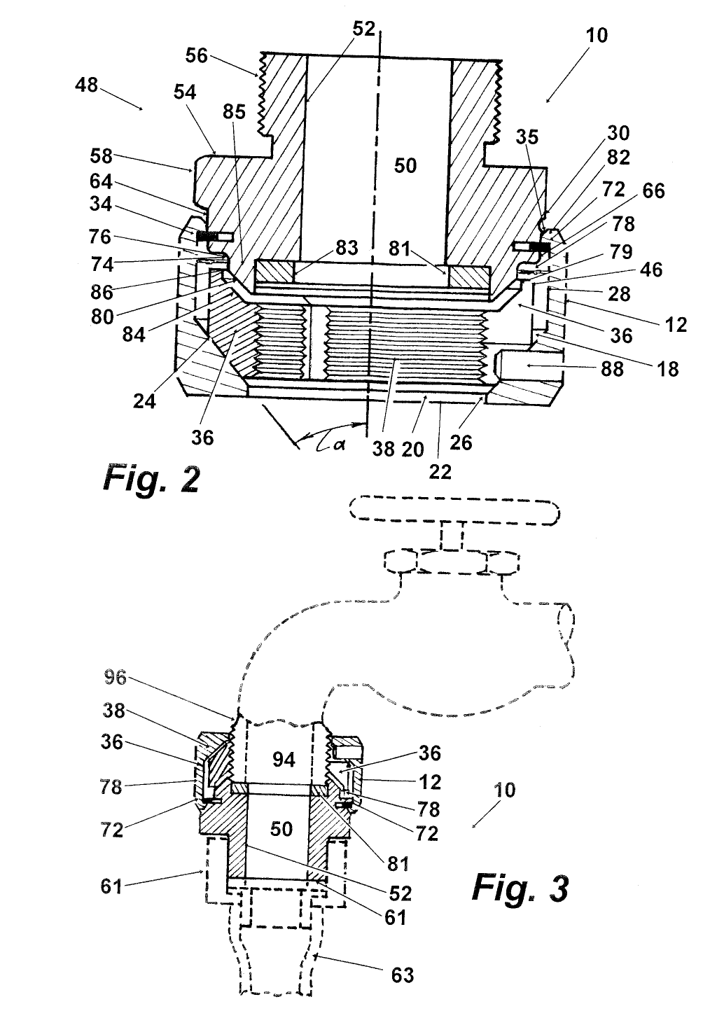

Referring now to the drawings and particularly to FIGS. 1A, 1B, and 2, therein is illustrated a coupler 10 in accordance with one embodiment of the invention, comprised of an outer casing 12 having a plurality of axial projections 14 for rotating the casing by hand. The interior walls of the casing define a cavity 18 extending there through. The lower end of the cavity terminates in a hole 20 extending axially through an insertion end 22 of the casing 12. The hole 20 can be round with a diameter slightly greater than the outside diameter of threaded hose spigot nozzle 94 (shown in FIG. 3) that is inserted into the insertion end 22 of the casing 12.

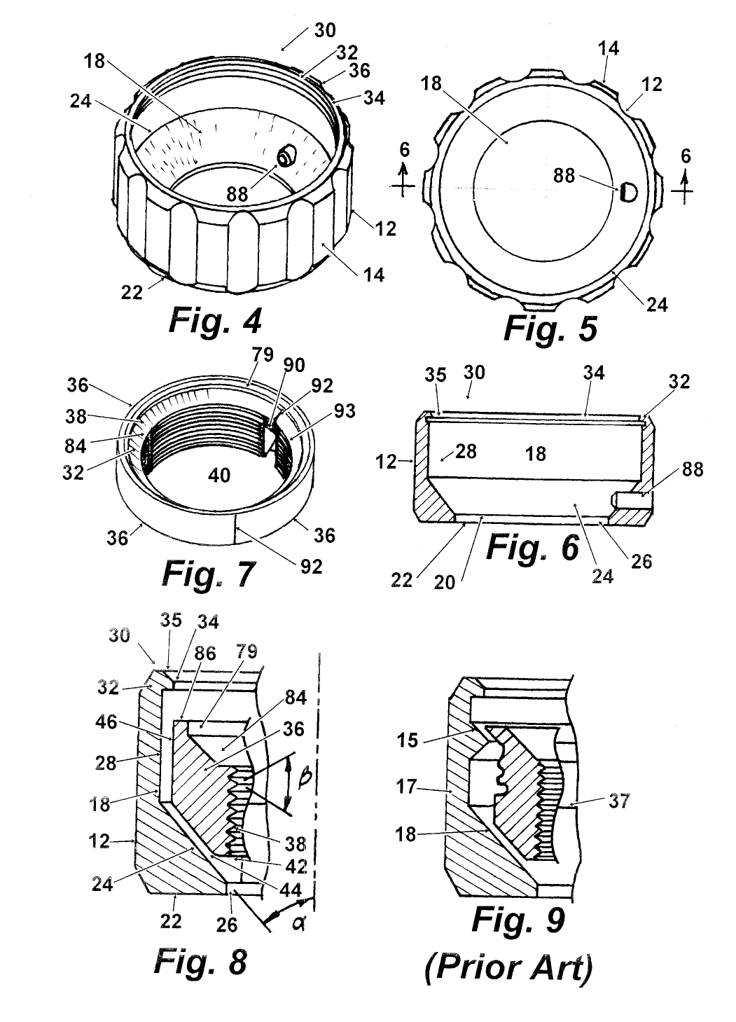

Turning additionally to FIGS. 4-6, the cavity 18 is defined partially by a frustoconical surface 24 i.e. an inclined surface of revolution extending at an acute angle α to the axis of the casing 12, radially outward from the interior of the cavity 18 in the direction toward the insertion end 22 of the casing 12. The minimum diameter of the inclined surface 24 is preferably the same as that of hole 20 and this surface may be spaced from the end of the casing 12 by a cylindrical surface 26.

The wall of the cavity extends in a wall section 28 from the maximum diameter of the inclined surface 24, toward the other end 30 of the casing 12 opposite to the insertion end 22. Wall section 28 extends generally axially and terminates at lip 32. Lip 32 includes a wall section 34, which extends axially until terminating at inclined surface 35, which extends to the end 30 of the casing 12.

FIG. 7 illustrates a plurality of internally threaded segments 36 having accurate cross sections in planes perpendicular to the axis of the coupler 12. In one embodiment, the number of thread segments 36 should be at least three, or more, as is further discussed herein. As FIGS. 1B and 2 show, these segments 36 are positioned within cavity 18, the segments preferably (although not necessarily) defining generally equal arcs. The segments 36 have internal threads 38 coaxial with the casing 12, and when arranged together, the segments 36 define a bore 40 into which is inserted a threaded spigot nozzle 94. The threads 38 have an apex angle β as illustrated in FIG. 8.

Still referring to FIG. 8, the ends 42 of the segments, which are placed nearest the insertion end 22 of the casing 12 each have a frustoconical surface 44 extending at the acute angle α to the axis of the casing 12. The inclined surface 44 is adapted to abut and slide on the frustoconical surface 24 of the casing 12. The inclined surface 44 extends radially outward in the direction away from the insertion end 22 of the casing 12, and terminates generally axially extending actuate wall 46 having length approximate to that of the wall section 28 of the cavity 18. Actuate wall 46 extends axially until terminating at the substantially planer ends 86 of the segments 36.

The coupler's employment of a single frustoconical surface 24 of revolution in casing 12 co-acting with the frustoconical revolution surfaces 44 of the segments 36 eliminates the use of dual frustoconical surfaces present in the prior art. Consequently, the coupler is simpler in design and stronger in resisting larger pulling forces, which could separate the coupler 10 from a hose spigot nozzle 94. FIG. 8 shows the width of a single frustoconical surface 24 of casing 12 compared to FIG. 9, which shows the width of a dual-frustoconical surface 13, 15 and casing 17 of the prior art. Here, if the single surface 24 width is equal to the combined dual surface 13, 15 widths, it has been found that a coupler employing the single surface design is more resistant to pulling forces than the dual surface design. It is believed that the single surface design results in a coupler being up to four times more resistant to pulling forces than the dual surface design. This added strength is important in situations where the threaded member and coupler are likely to be placed under significant pulling force strain.

The dual surface design of the prior art fasteners also inhibits their machine assembly. The upper frustoconical surface 15 shown in the prior art fastener casing 17 of FIG. 9 creates an obstruction to easy loading of the casing with segments 37 during manufacture. As a result, only labor-intensive hand manufacture was practical as machinery can not easily negotiate the upper surface 15 in the prior art casings 17. The elimination of this upper frustoconical surface in the present invention makes for easy machine loading of the segments during manufacture.

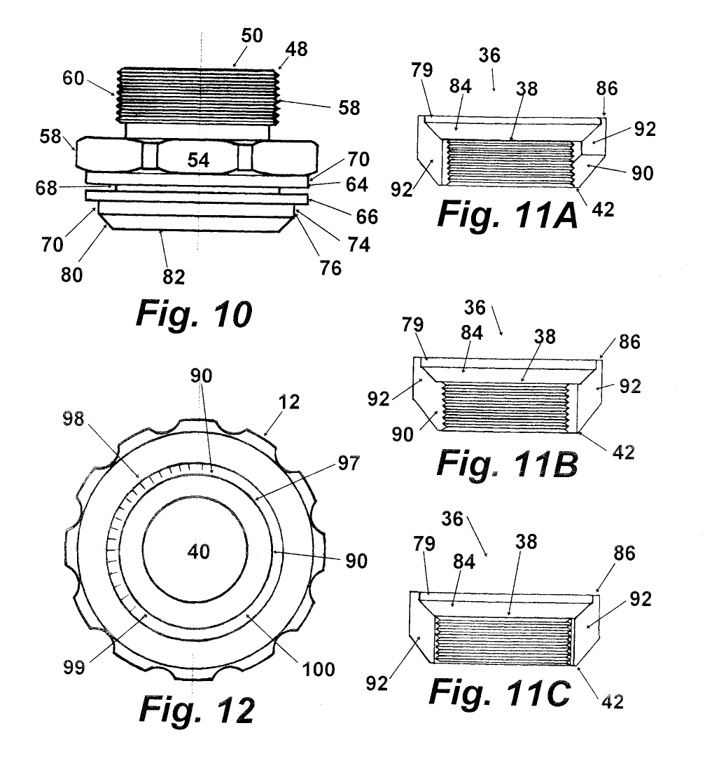

Referring again to FIGS. 1A-1B and now to FIG. 10, the segments 36 are axially retained in the casing 12 at end 30 by a cap or cover 48. Inclined surface 35 of lip 32 on casing helps to center and guide the cover 48 during assembly. Cover 48 has a central hole 50 extending there-through, preferably of a smaller diameter than hole 20 to reduce to reduce fluid turbulence. A circular inner wall section 52 defines hole 50 and exterior to hole. The top cap 48 is comprised of turning flange 54 and hose flange 56. Turning flange 54 may have an octagonal axial outer wall section 58, for example, to allow turning by a wrench. The axial circular exterior wall section 60 of hose flange 56 is threaded to allow male connection with the female threaded nozzle-connecting end 61 of a garden hose 63, for example, as shown in FIG. 3. In this way, a common garden hose 63 can be connected to the coupler 10, to allow quick engagement of the hose 63 to any spigot nozzle 94 of standard diameter.

Referring to FIGS. 10 and 2, the side of the cover positioned toward the lip 32 of the casing 12 has a first ring portion 64, which abuts against wall section 34 of lip 32. A second ring portion 66 has a diameter that is approximately equal to the first ring portion 64 and is axially spaced from the first ring portion. In between the two ring portions 64, 66 there is an axial gap 68 which extends radially inward of the cover 48 to terminate at exterior wall section 70. A snap ring 72 (see FIG. 6) is placed in the gap 68, or similar device to allow the cover 45 to be snapped into casing 12 and retained therein. The snap ring 72 allows the cover 48 to rotate in relation to the casing 12, while being held in the casing 12 due to its expansion beneath lip 32. An exterior circular wall section 74 having a diameter less than ring portions 64, 66 extends from second ring portion 66.

The junction at the second ring portion 66 and the wall section 74 forms a corner area 76 with a frustoconical surface 80 that is undercut with an angle less than the angle α to the axis of the coupler 10. This undercut with respect to the angle α provides extra clearance to accommodate for radius mismatch. The radially inner end of the frustoconical surface 80 terminates at hole 82, which has wall section 85 defining a washer cavity 83. Washer cavity 83 is circular, having a diameter for snugly retaining a standard rubber hose washer 81 against the wall section 85. When a washer 81 is placed within washer cavity 83, the washer has an inside diameter that is approximate equal to the diameter of hole 50. Upon insertion of spigot nozzle 94 (see FIG. 3), the washer seats against the end of nozzle 94, thereby directing any flow of fluid into hole 50.

Referring again to FIGS. 2 and 3, it is seen how threaded segments 36 have a frustoconical surface 84 inclined at the angle α to the axis of the casing 12 and facing and adapted to slide on the inclined surface 80 of the cover 48. Frustoconical surface 84 extends radially from threads 38 and terminates at wall section 79, which proceeds axially until reaching end 86. The hose coupler 10 is further provided with a means for resiliently biasing the threaded segments 36 in the radially inward direction of the coupler 10. For example, a wave spring 78 may be positioned at the confluence of corner area 76 of cover 48 and substantially planar ends 86 of segments 36.

The wave spring 78 exerts pressure between the relatively unyielding cover 48 and movable segments 36, forcing the segments to naturally move radially inward of the casing 12. When a spigot nozzle 94 is inserted into the insertion end 22 of the casing, the segments 36 move radially outward as the inner threads 38 of the segments 36 ride over the high points of the threads on the spigot nozzle 94, and likewise the segments 36 move radially inward as the high points of the threads 38 of the segments 36 settle in the valleys of threads 96 of the spigot nozzle 94. Upon insertion of the spigot nozzle 94, the wave spring 78 biases both the inward and outward radial action as the segments 36 slide along frustoconical surface 24 of the casing 12.

In the hose coupler 10 of FIG. 2, it is also necessary to provide a means for inhibiting the relative rotation between the casing 12 and the segments 36. For this purpose, a single segment pin 88 presses into the frustoconical surface 24 of the casing 12 and projects radially outward into the cavity 18 to prevent segment rotation (see FIG. 6). As shown in FIG. 7, in a three-segment arrangement, two of the adjacent threaded segments 36 are each grooved 90 at their adjoining surfaces 92 to allow clearance for one half of the segment pin 88. When the adjoining surfaces 92 meet, a keyway 93 is formed for allowing the through-passage of segment pin 88.

The placement of the segment pin 88 near the insertion end 22 of the casing 12 as seen in FIG. 2, allows for the unobstructed loading of the segments into the casing 12 from end 80. This allows for simpler assembly of the coupler 10 during manufacture when compared to prior art couplers and fasteners which position multiple segment pins at opposite upper end of casing, thereby causing an obstructed and more complicated assembly of segments into the casing. Furthermore, the segment pin 88 helps prevent the thread segments 36 from rolling downward into the casing 12 and partially covering the insertion end 22 where the spigot nozzle 94 enters the coupler 10.

Referring to FIGS. 11A-C, a further reason for grooving the adjacent segments can be described. The adjacent grooves 90 insure that two segments 36 (see FIGS. 11A-11B) having matching threads 38 are placed adjacent to the keyway 93. The third segment 36 (see FIG. 11C) has no groove and is matched to the non-grooved segments to form the three-segment arrangement shown in FIG. 7. In this way, matching segments 36 can be easily identified during manufacture and quickly assembled in proper order into the casing 12 of the coupler 10. This segment identifying means further facilitates machine assembly of the coupler. The grooves 90 allow the segments 36 shown in FIGS. 11A-C to be identified and separated out by an assembly machine using a laser scanner. The two grooved 90 segments 36, not being mirror images, are easily identifiable, and the non-grooved segment 36 is readily identifiable from the two grooved segments. Upon identification, these segments 36 can be segregated from plurality of segments by well-known mechanical means and assembled into coupler 10 in the proper order.

In the arrangement of the invention, illustrated in FIG. 3, it is apparent that, when a threaded spigot nozzle 94 is inserted into the coupler 10 via hole 20, engagement of the threads 38 of the segments 36 cause an axial force to be applied to the segments, thereby resulting in the axial as well as the radial outward movement of the segments 36 due to sliding contact between the frustoconical surface 44 of the segments 36 and the adjacent single frustoconical 24 surface of the casing 12. This radial outward movement of segments 36 permits the nozzle 94 to be rapidly inserted into the coupler 10 without the necessity of threading the coupler into the nozzle. The frustoconical surfaces 44, 84 on the segments 36 are guided during axial movement by the frustoconical surface 80 of the cover 48, which also inhibits inward pivotal movement of the segments 36 so they do not roll into the casing cavity 18.

Upon rotation of the casing 12 to tighten the coupler 10, following the initial axial insertion of the spigot nozzle 94, the threads 38 of the segments 36 engage the threads 96 of the spigot nozzle 94 and are forced axially toward the insertion end 22 of the coupler 10. This results in the segments 36 being guided by the single frustoconical surface 24 of the casing 12 to move radially inward and hence to be forced radially inward against the threads 96 of the nozzle 94.

In accordance with one embodiment of the invention, the acute angle α of the frustoconical surfaces of the casing, cover and segments 24, 80, 44, 84 with respect to the axis of the coupler 10 is less than the apex angle β of the threads 38 of the segments 36. It has been found that this relationship improves the holding power of the coupler. That is, this relationship renders the release of the coupler 10 from the spigot nozzle 94 more difficult. In other words, the inclined thread surfaces, in an axial place of the coupler, extend at greater acute angles to the axis of the coupler than the frustoconical surfaces of the casing, cover, and segments. As an example, when a spigot nozzle has threads with an apex angle β of 60°, it has been found advantageous to form frustoconical surfaces on the casing, cover, and segments 24, 80, 44, 84 with angles α of about 45° to the axis of the coupler 10.

While three segments are provided in the coupler illustrated so far, the invention is not limited to this number. For example, FIG. 12 shows a coupler 10 with four segments 97, 98, 99 100 of substantially equal are length. It is generally advisable to increase the number of segments as a function of the diameter of the spigot nozzle 94 that is to be accommodated therein. Also, couplers having even-numbered segments can be used on spigot nozzles having entirely different thread pitches. For example in FIG. 12, opposing thread segments 97, 99 could adapt to standard threads, while thread segments 98, 100 could adapt to metric threads.

The structures and methods herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention. All modifications to the embodiments described herein that come within the meaning and range of equivalence of the claims are embraced within the scope of the invention.

What is claimed is:

1. A threaded coupler comprising:
a) a plurality of circumferentially distributed internally threaded segments arranged to create a bore for inserting an externally threaded member;
b) a casing surrounding the threaded segments, the casing having a first inclined surface of revolution extending at an acute angle to an axis of the coupler; and
b) a spring that resiliently urges the segments radially inward to the axis of the coupler, each of the plurality of segments having an inclined surface which defines a second inclined surface of revolution co-acting with the first inclined surface of revolution of the casing.

2. The coupler of claim 1 wherein the first and second inclined surfaces of revolution are positioned proximate an insertion end of the coupler.

3. The coupler of claim 1 wherein each of the plurality of segments have a substantially planar end that is axially spaced from the inclined surface of the segment.

4. The coupler of claim 3 wherein the spring that resiliently urges the segments comprises a wave spring that is seated upon and co-acting with the substantially planar end of the plurality of segments.

5. The coupler of claim 3 wherein the spring that resiliently urges the segments radially inward comprises a spring that is radially biased against the substantially planar ends of the plurality of segments.

6. The coupler of claim 5 further comprising a cover that retains the casing, wherein the spring is positioned between the cover and the substantially planar ends of the segments.

7. The coupler of claim 1 further comprising a segment pin protruding from the casing in a radially inward direction.

8. The coupler of claim 7 wherein the segment pin protrudes from the first inclined surface of revolution.

9. The coupler of claim 7 wherein the segment pin is positioned to co-act with an end of the segment nearest an insertion end of the coupler.

10. The coupler of claim 9 wherein two adjacent threaded segments are each grooved at ends nearest the insertion end the coupler so as to allow a predetermined clearance around one-half of the segment pin.

11. The coupler of claim 1 wherein an inside diameter of the bore is substantially equal to an outside diameter of a threaded household spigot nozzle.

12. A threaded coupler comprising:
a) a plurality of circumferentially distributed internally threaded segments arranged to create a bore for inserting an externally threaded member;
b) a casing surrounding the segments, the casing having a first inclined surface of revolution extending at an acute angle to an axis of the coupler;
c) a means for resiliently urging the segments radially inward to the axis of the coupler, wherein each of the plurality of segments includes an inclined surface that defines a second surface of revolution co-acting with the first inclined surface of revolution of the casing; and
d) a means for identifying individual thread segments and ordering them within the coupler.

13. A threaded coupler comprising:
a) at least three circumferentially distributed internally threaded segments arranged to create a bore for inserting an externally threaded member;
b) a means for resiliently urging the segments radially inward to an axis of the coupler; and
c) a means for identifying individual thread segments and ordering them within the coupler.

14. The coupler of claim 13 further comprising a casing, wherein the segments are in a desired order within the casing, the casing having a first incline surface of revolution extending at an acute angle to the axis of the coupler, each of the segments having an inclined surface which defines a second surface of revolution co-acting with the first inclined surface of revolution of the casing.

15. The coupler of claim 14 wherein the first and second inclined surfaces of revolution are located proximate to an insertion end of the coupler.

16. The coupler of claim 14 wherein each of the threaded segments have substantially planar ends axially spaced from the inclined surface of the segment.

17. The coupler of claim 16 wherein the means for resiliently urging the segments comprises a wave spring seated upon and co-acting with the substantially planar ends of the segments.

18. The coupler of claim 13 wherein the means for resiliently urging the segments radially inward comprises a spring radially biasing against the planar ends of the segments.

19. The coupler of claim 18 further comprising a cover for retaining the segment within the casing, the spring being positioned between the cover and the substantially planar surfaces of the segments.

20. The coupler of claim 13 further comprising a segment pin protruding from the casing in a radially inward direction.

21. The coupler of claim 20 wherein the segment pin protrudes from the first inclined surface of revolution.

22. The coupler of claim 20 wherein the segment pin is positioned to co-act with an end of the segment proximate to an insertion end of the coupler.

23. The coupler of claim 13 wherein the means for identifying thread segments includes two adjacent thread segments being grooved to allow clearance around one-half of the segment pin.

24. The coupler of claim 23 wherein the two adjacent threaded segments are grooved at their ends proximate to the insertion end of the coupler.

25. The coupler of claim 13 wherein an inside diameter of the bore is substantially equal to an outside diameter of a threaded household spigot nozzle.
